(19) United States
(12) Patent Application Publication
(10) Pub. No.: US 2020/0028773 A1
(43) Pub. Date: Jan. 23, 2020

(54) COMMUNICATION CONTROL SYSTEM AND COMMUNICATION CONTROL METHOD

(71) Applicant: FUJITSU LIMITED, Kawasaki-shi (JP)

(72) Inventor: Daisuke Ito, Kawasaki (JP)

(73) Assignee: FUJITSU LIMITED, Kawasaki-shi (JP)

(21) Appl. No.: 16/509,557

(22) Filed: Jul. 12, 2019

(30) Foreign Application Priority Data
Jul. 18, 2018 (JP) 2018-134635

(51) Int. Cl. H04L 12/751; H04L 12/801; G06F 13/12; G06F 13/42

(52) U.S. Cl. CPC H04L 45/10; G06F 13/423; G06F 13/122; H04L 47/14

(57) ABSTRACT

A communication control system includes a first processor, and a second processor coupled to the first processor via a plurality of communication lines and the second processor configured to select, for each packet of a plurality of packets, a communication line from the plurality of communication lines in specific order, and sequentially transmit each packet of the plurality of packets by using the selected communication line of the plurality of communication lines, wherein the first processor is configured to sequentially receive each packet of the plurality of packets by selecting a communication line from the plurality of communication lines in the specific order.

### CROSS-REFERENCE TO RELATED APPLICATION

This application is based upon and claims the benefit of priority of the prior Japanese Patent Application No. 2018-134635, filed on Jul. 18, 2018, the entire contents of which are incorporated herein by reference.

### FIELD

The embodiments discussed herein are related to communication control technology.

### BACKGROUND

FIG. 8 is a diagram illustrating a configuration of a communication control system of related art. The communication control system illustrated in FIG. 8 communicably connects between chips 501a to 501c.

The chips 501a to 501c are arithmetic processing units such as a central processing unit (CPU) or a graphics processing unit (GPU) included in an information processing apparatus, for example. The chip 501a includes a plurality of cores 510, a crossbar (XB) 511 and a plurality of (four in the example illustrated in FIG. 8) ports 5012a-1 to 512a-4.

The cores 510 are arithmetic cores each performing arithmetic processing. The plurality of cores 510 and ports 512a-1 to 512a-4 are connected with the crossbar 511. As the references indicating ports included in the chip 501a, the references “512a-1” to “512a-4” are used for specifying corresponding ones of the plurality of ports, but the reference “512” is used for indicating an arbitrary one of the plurality of ports.

The crossbar 511 is a connection change switch and changes the connections between the cores 510 and the plurality of ports 512a-1 to 512a-4.

In other words, for example, in the chip 501a, each of the cores 510 is connected with the plurality of ports 512 through the crossbar 511. The crossbar 511 switches between the connections so that each of the cores 510 may be connected to an arbitrary one of the ports 512.

The chip 501b includes one core 510, a crossbar 511, and a plurality of (two in FIG. 8) ports 512b-1 and 512b-2. The chip 501c includes one core 510, a crossbar 511, and a plurality of (two in FIG. 8) ports 512c-1 and 512c-2, like the chip 501a.

As the references indicating chips, the references “501a”, “501b”, and “501c” are used for specifying corresponding ones of the plurality of chips, but the reference “501” is used for indicating an arbitrary one of the plurality of chips.

The port 512a-2 of the chip 501a is connected to the port 512b-2 of the chip 501b through a link 520-1. The port 512a-4 of the chip 501a is connected to the port 512c-2 of the chip 501c through a link 520-2. In other words, for example, one port 512 is used to connect between the chips 501.

In this configuration, for example, a plurality of packets submitted from the core 510 to the port 512a-2 in the chip 501a is taken out in the order of the submission from the port 512b-2 in the receiving chip 501b.

The order of the plurality of packets to be transferred from the transmitting chip 501 to the receiving chip 501 does not change without overtaking on the one link 520-1 or 520-2.

Also, for example, in one chip 501 (such as the chip 501a), packet relay may be implemented in which one port 512 (such as the port 512a-4) that is a transmitting side is connected to another port 512 (such as the port 512a-2) through the crossbar 511.

For example, Japanese Laid-open Patent Publication No. 11-68758 and Japanese Laid-open Patent Publication No. 2001-168866 disclose related art.

### SUMMARY

According to an aspect of the embodiments, a communication control system includes a first processor, and a second processor coupled to the first processor via a plurality of communication lines and the second processor configured to select, for each packet of a plurality of packets, a communication line from the plurality of communication lines in specific order, and sequentially transmit each packet of the plurality of packets by using the selected communication line of the plurality of communication lines, wherein the first processor is configured to sequentially receive each packet of the plurality of packets by selecting a communication line from the plurality of communication lines in the specific order.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining an outline of a communication control system as an example of an embodiment;

FIG. 2 is a diagram for explaining how packets are to be transmitted in the communication control system as an example of the embodiment;

FIG. 3 is a diagram illustrating a configuration of a transmission toggle unit in the communication control system as an example of the embodiment;

FIG. 4 is a diagram illustrating a configuration of a reception toggle unit in the communication control system as an example of the embodiment;

FIG. 5 is a flowchart for explaining processing relating to data communication in the communication control system as an example of the embodiment;

FIG. 6 is a flowchart for explaining processing to be performed by the transmission toggle unit in the communication control system as an example of the embodiment;

FIG. 7 is a flowchart for explaining processing to be performed by the reception toggle unit in the communication control system as an example of the embodiment;

FIG. 8 is a diagram illustrating a configuration of a communication control system of related art; and

FIG. 9 is a diagram illustrating a configuration in a case where data communication is performed between chips through a plurality of links in a communication control system of related art.

### DESCRIPTION OF EMBODIMENTS

In the communication control system 500 of related art, it may be considered that a plurality links are used in parallel for data transfer between the chips 501 in a case where the throughputs between the chips 501 are insufficient.

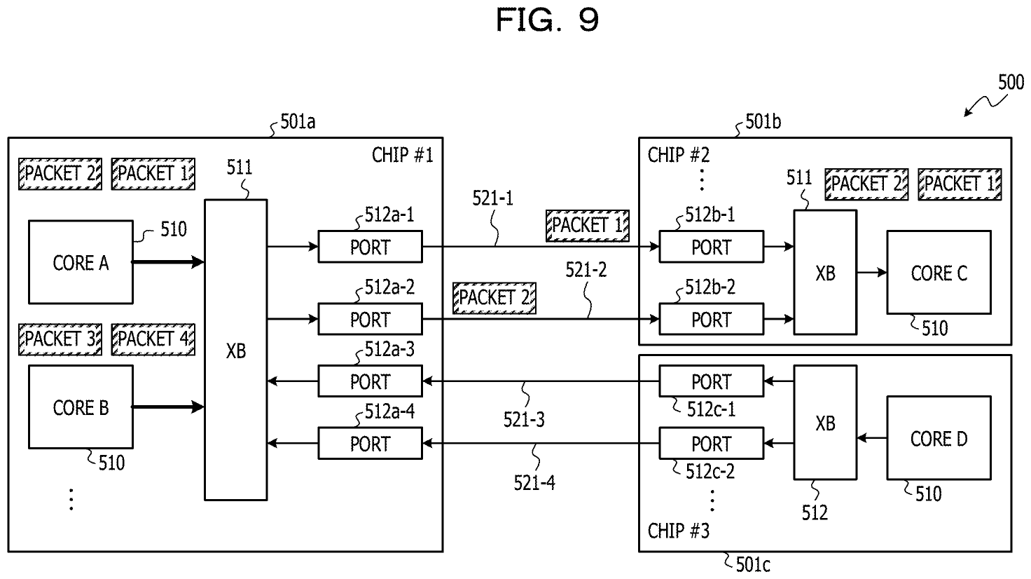

FIG. 9 is a diagram illustrating a configuration in a case where data communication is performed between chips through a plurality of links in the communication control system of related art. Because like numbers and references described above refer to like parts in the drawings, any repetitive descriptions will be omitted.

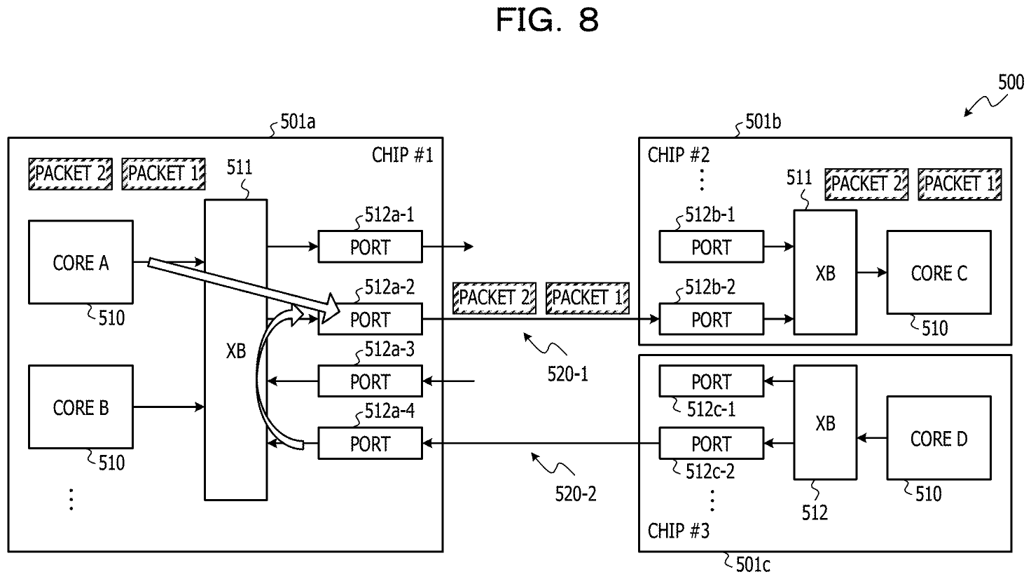

Referring to FIG. 9, the port 512a-1 of the chip 501a and the port 512b-1 of the chip 501b are connected through a link 521-1, and the port 512a-2 of the chip 501a and the port 512b-2 of the chip 501b are connected through a link 521-2. Thus, the chip 501a and the chip 501b are connected through the two links 521-1 and 521-2 in parallel, and the throughput doubles compared with the configuration illustrated in FIG. 8.

The port 512a-3 of the chip 501a and the port 512c-1 of the chip 501c are connected through a link 521-3, and the port 512a-4 of the chip 501a and the port 512c-2 of the chip 501c are connected through a link 521-4. Thus, the chip 501a and the chip 501c are connected through the two links 521-3 and 521-4 in parallel, and the throughput doubles compared with the configuration illustrated in FIG. 8.

Even in a case where the plurality of chips 501 is connected through the plurality of links 521 as illustrated in FIG. 9, there is a demand for receiving, by the receiving chip 501, packets in order of transmission from the core 510 of the transmitting chip 501.

However, the ports 512 (and links 521) of the chips 501 have different statuses of use. Therefore, when the plurality of ports 512 transmits packets, packet overtaking may occur between the plurality of links 521. Due to the occurrence of packet overtaking between the plurality of links 521, the receiving chip 501 may not process the received packets properly.

Embodiments relating to a communication control system and a communication control method will be described below with reference to drawings. However, the following embodiments are given for illustration purpose, and it is not intended that various variation examples and application of technologies that are not clearly stated in the embodiments are excluded. In other words, for example, the embodiments may be implemented in various forms (including a combination of one of the embodiments and a variation example) without departing from the spirit and cope of the embodiments. The drawings are not intended to illustrate that the drawn components are provided, but the embodiments may include other functions and so on.

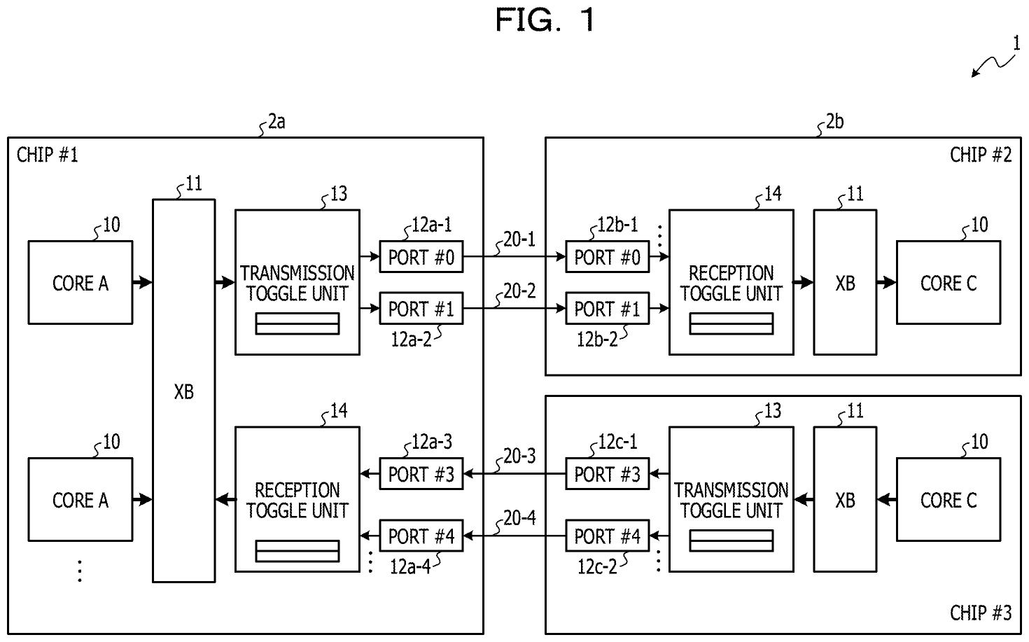

First, an outline of a communication control system 1 as an example of an embodiment will be described with reference to FIG. 1. The communication control system 1 illustrated in FIG. 1 communicably connects between a plurality of (three in the example illustrated in FIG. 1) chips 2a to 2c.

The chips 2a to 2c are arithmetic processing units such as a CPU or a GPU. An example in which the chips 2a to 2c are CPUs will be described below.

In other words, for example, the communication control system 1 illustrated in FIG. 1 is included in an information processing apparatus (communication control apparatus) and mutually connects the chips 2a to 2c implemented in the information processing apparatus. Each of the chips 2a to 2c may execute a communication control program including a plurality of instructions to implement a communication control method that will be disclosed below.

The chip 2a includes a plurality of (two in the example illustrated in FIG. 1) cores 10, a crossbar (XB) 11, a transmission toggle unit 13, a reception toggle unit 14, and a plurality of (four in the example illustrated in FIG. 1) ports 12a-1 to 12a-4.

As the references indicating the ports, the references “12a-1” to “12a-4”, “12b-1” and “12b-2”, and “12c-1” to “12c-2” are used for specifying corresponding ones of the plurality of ports, but the reference “12” is used for indicating an arbitrary one of the plurality of ports.

The cores 10 are arithmetic cores each performing arithmetic processing. The plurality of cores 10, the transmission toggle unit 13 and the reception toggle unit 14 are connected with the crossbar 11. The ports 12a-1 and 12a-2 are connected with the transmission toggle unit 13, and the ports 12a-1 and 12a-2 are thus connected with the crossbar 11 through the transmission toggle unit 13. The ports 12a-3 and 12a-4 are connected with the reception toggle unit 14, and the ports 12a-3 and 12a-4 are thus connected with the crossbar 11 through the reception toggle unit 14.

The crossbar 11 is a connection change switch and is configured to change the connections between the cores 10 and the transmission toggle unit 13 and the reception toggle unit 14.

In the chip 2a, the cores 10 are connected with the plurality of ports 12 through the crossbar 11 and the transmission toggle unit 13 or the reception toggle unit 14. The crossbar 11 switches between the connections so that each of the cores 10 may be connected with an arbitrary one of the ports 12.

The chip 2b includes one core 10, a crossbar 11, and a plurality of (two in FIG. 1) ports 12b-1 and 12b-2. The chip 2c includes one core 10, a crossbar 11, and a plurality of (two in FIG. 1) ports 12c-1 and 12c-2, like the chip 2b. Because like numbers and references described above refer to like parts in the drawings, any repetitive descriptions will be omitted.

As the references indicating chips, the references “2a”, “2b”, and “2c” are used for specifying corresponding ones of the plurality of chips, but the reference “2” is used for indicating an arbitrary one of the plurality of chips. The chip 2a may also be called “chip #1”. The chip 2b and chip 2c may also be called “chip #2” and “chip #3”, respectively.

The port 12a-1 of the chip 2a is connected with the port 12b-1 of the chip 2b through a link 20-1. The port 12a-2 of the chip 2a is connected with the port 12b-2 of the chip 2b through a link 20-2. These links 20-1 and 20-2 are paired and are used for data transmission from the chip 2a to the chip 2b. The paired links 20-1 and 20-2 may also be called “pair links 20”.

The port 12a-3 of the chip 2a is connected with the port 12c-1 of the chip 2c through a link 20-3. The port 12a-4 of the chip 2a is connected with the port 12c-2 of the chip 2c through a link 20-4. These links 20-3 and 20-4 are included in pair links 20 and are used for data transmission from the chip 2c to the chip 2a.

As the references indicating links, the references “20-1” to “20-4” are used for specifying corresponding ones of the plurality of links, but the reference “20” is used for indicating an arbitrary one of the plurality of links.

In the communication control system 1, the two links 20 (ports 12) are used for data transmission between the chips 2. This doubles the throughput compared with the case where one link 20 is used for data transmission between the chips 2.

In the chip 2a, the ports 12a-1 and 12a-2 are used for data transmission to the chip 2b. These ports 12a-1 and 12a-2 may also be called “transmission ports 12a-1 and 12a-2”. The transmission port 12a-1 may also be called “Port #0”, and the transmission port 12a-2 may also be called “Port #1”. The number subsequent to the sign “#” is a port number for identifying a port 12. In other words, for example, the port number of Port #0 is “0”, and the port number of Port #1 is “1”.

In the chip 2a, the ports 12a-3 and 12a-4 are used for data reception from the chip 2c. These ports 12a-3 and 12a-4 may also be called “reception ports 12a-3 and 12a-4”. The reception port 12a-3 may also be called “Port #3”, and the reception port 12a-4 may also be called “Port #4”.

Also, in the chip 2b, the ports 12b-1 and 12b-2 are used for data reception from the chip 2a. These ports 12b-1 and 12b-2 may also be called “reception ports 12b-1 and 12b-2” or may simply be called “reception ports 12”. In the chip 2b, the reception port 12b-1 may also be called “Port #0”, and the reception port 12b-2 may also be called “Port #1”.

In the chip 2c, the ports 12c-1 and 12c-2 are used for data transmission to the chip 2a. These ports 12c-1 and 12c-2 may also be called “transmission ports 12c-1 and 12c-2” or may simply be called “transmission ports 12”. The transmission port 12c-1 may also be called “Port #3”, and the transmission port 12c-2 may also be called “Port #4”.

In the communication control system 1, the chips 2 are connected through the links 20 by connecting the ports 12 having the same port number for one link. For example, in the example illustrated in FIG. 1, the link 20-1 has one end connected to the transmission port 12a-1 having the port number “0” in the chip 2a and the other end connected to the reception port 12b-1 having the port number “0” in the chip 2b.

Data are communicated in packets between the chips 2. In other words, for example, data to be communicated include a plurality of packets (packet group). Each of the packets has a variable length (non-fixed length) size. Each of the packets may have a fixed length size.

In packet transmission through the links 20, a subsequent packet does not overtake the preceding packet within one link 20.

Also, a packet received from one port 12 through the reception toggle unit 14 may be directly output from another port 12 through the crossbar 11 and the transmission toggle unit 13.

FIG. 1 illustrates thick arrows indicating a high-throughput state and thin arrows indicating a low-throughput state. For example, the throughputs of the connection between the crossbar 11 and the cores 10, the transmission toggle units 13 and the reception toggle units 14 are higher than the throughputs between the ports 12 (in the links 20).

In the communication control system 1, the transmission toggle unit 13 is provided between the crossbar 11 and the transmission ports 12, and the reception toggle unit 14 is provided between the crossbar 11 and the reception ports 12.

For convenience of illustration, FIG. 1 illustrates an example in which the chip 2a transmits data to the chip 2b and the chip 2c transmits data to the chip 2a. In other words, for example, for convenience of illustration, the transmission ports 12, the transmission toggle unit 13, the reception ports 12 and the reception toggle unit 14 are illustrated in the chip 2a, and the reception ports 12 and the reception toggle unit 14 are illustrated in the chip 2b, and the transmission port 12 and the transmission toggle unit 13 are illustrated in the chip 2c.

However, embodiments are not limited thereto. For example, the transmission ports 12 and the transmission toggle unit 13 may be provided in the chip 2b, and the reception port 12 and the reception toggle unit 14 may be provided in the chip 2c.

Then, for example, the chip 2a may transmit data to the chip 2c or another chip 2 that is not illustrated. The chip 2b may transmit data to the chip 2a and perform data communication with the chip 2c or another chip 2 that is not illustrated. Also, the chip 2c may receive data from the chip 2a and perform data communication with the chip 2b or another chip 2 that is not illustrated.

In the example illustrated in FIG. 1, for example, the chip 2a corresponds to a transmitting apparatus and a transmitting unit, and the chip 2b corresponds to a receiving apparatus and a receiving unit.

The transmission toggle unit 13 transmits data (packet group) to another chip 2 by switching, for each packet and in predetermined order, between the plurality of transmission ports 12 to be used for the data transmission.

According to this embodiment, the transmission toggle unit 13 performs toggle switching that alternately switches between the two transmission ports 12 every time a packet is transmitted (or for each packet).

The transmission toggle unit 13 changes the transmission port 12 at the end of a transmitted packet so that switching between the transmission ports 12 is performed for each packet.

For example, in the chip 2a, to transmit data (packet group) to the chip 2b, the transmission toggle unit 13 switches between the transmission port 12a-1 and the transmission port 12a-2 for each one packet.

Thus, the transmission port 12 (link 20) to be used for packet transmission is alternately changed every time one packet is transmitted (or for each packet). In other words, for example, the transmission toggle unit 13 transmits data by alternately switching between the link 20-1 and the link 20-2 for each packet.

For performing data communication, the transmission toggle unit 13 in the data transmitting (source) chip 2 and the reception toggle unit 14 in the data receiving (destination) chip 2 preset the starting ports 12 before start of the data communication such that the ports 12 connected to one link 20 are selected between the plurality of (two) links 20 included in the pair links 20.

For example, the transmission toggle unit 13 and the reception toggle unit 14 may preset the ports (priority transmission port and the priority reception port) 12 to be used first. Then, the transmission toggle unit 13 and the reception toggle unit 14 may select the ports 12 to be used first in accordance with the presetting.

More specifically, for example, the transmission toggle unit 13 and the reception toggle unit 14 set the ports 12 having the same port number (such as the port number “0”) as the starting ports 12.

The link 20 to perform packet communication first of the two links 20 included in the pair links 20 may also be called a “starting link 20”. The transmission port 12 and the reception port 12 connected to the starting link 20 are the starting ports 12 to be used first for packet communication.

A controller or another information processing apparatus, for example, not illustrated, may instruct the transmission toggle unit 13 to use information (such as the port number) for identifying the priority transmission port 12 and instruct the reception toggle unit 14 to use information (such as the port number) for identifying the priority reception port 12. The transmission toggle unit 13 and the reception toggle unit 14 may select the ports 12 to be used first in accordance with the instructions.

The transmission toggle unit 13 functions as a first switching unit that changes the transmission port 12 (link 20) to be used for packet transmission for each packet in predefined order (or sequentially).

The reception toggle unit 14 receives data (packet group) from the other chip 2 by switching, for each packet and in predetermined order, between the plurality of reception ports 12 to be used for the data reception.

According to this embodiment, the reception toggle unit 14 performs toggle switching that alternately switches between the two reception ports 12 every time a packet is received (or for each packet).

The reception toggle unit 14 changes the reception port 12 at the end of a packet so that switching between the reception ports 12 is performed for each packet.

For example, in the chip 2b, to receive data (packet group) from the chip 2a, the reception toggle unit 14 alternately switches between the reception port 12b-1 and the reception port 12b-2 for each one packet.

Thus, the reception port 12 (link 20) to be used for packet reception is alternately changed every time one packet is transmitted (or for each packet). In other words, for example, the reception toggle unit 14 receives data by alternately switching between the link 20-1 and the link 20-2 for each packet.

As described above, for performing data communication, the transmission toggle unit 13 in the data transmitting chip 2 and the reception toggle unit 14 in the data receiving chip 2 set the starting ports 12 before start of the data communication such that the ports 12 connected to one link 20 are selected.

For example, the reception toggle unit 14 may preset the reception port (priority reception port) 12 to be used first. Then, the reception toggle unit 14 may select the reception port 12 to be used first in accordance with the presetting. A controller or another information processing apparatus, for example, not illustrated, may instruct the reception toggle unit 14 to use the reception port 12 first, and the reception toggle unit 14 may select the reception port 12 to be used first in accordance with the instruction.

The transmission toggle unit 13 and the reception toggle unit 14 change the link 20 to be used for packet communication in the same order (alternately in this embodiment) between the plurality of (two in this embodiment) links 20 included in the pair links 20.

According to this embodiment, the transmission toggle unit 13 and the reception toggle unit 14 alternately switch between the ports 12 to be used every time one packet is communicated by starting from the instructed starting port number. This is called toggling.

The reception toggle unit 14 functions as a second switching unit that changes the reception port 12 (link 20) to be used for packet reception for each packet in the same predefined order (or sequentially) as that of the transmission toggle unit 13 in the data transmitting chip 2.

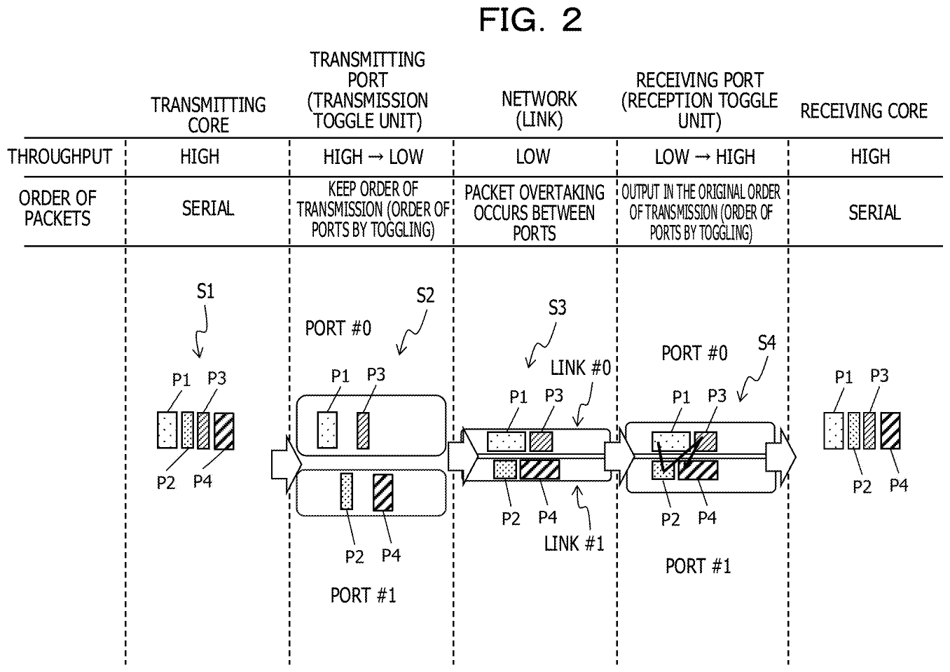

FIG. 2 is a diagram for explaining how packets are to be transmitted in the communication control system 1 as an example of the embodiment.

Referring to FIG. 2, the core 10 (hereinafter, transmitting core 10) in the transmitting chip 2 transmits four packets P1 to P4 to the core 10 (hereinafter, receiving core 10) in the receiving chip 2. The packets P1 to P4 do not have a fixed length (packet length).

Referring to FIG. 2, the sizes in the height direction (top-to-bottom direction) of the packets P1 to P4 indicate throughput performances. In other words, for example, a large size in the height direction of a packet indicates a high throughput state, and a small size in the height direction of a packet indicates a low throughput state. Referring to FIG. 2, the sizes in the lateral direction (right-to-left direction) of the packets P1 to P4 indicate transfer times. In other words, for example, a large size in the lateral direction of a packet indicates a state that transfer takes a long period of time, and a small size in the lateral direction of a packet indicates a state that transfer takes a short period of time.

Packet transfer takes a short period of time in a high throughput state, and packet transfer takes a long period of time in a low throughput state.

The transmitting core 10 generates the packets P1 to P4 and outputs the packets P1 to P4 to the crossbar 11 in (serial) order of P1, P2, P3, and P4 (see Reference S1). The chips 2 (CPUs) internally have a wide bus and produce a high throughput.

The packets P1 to P4 output from the transmitting core 10 are passed to the transmission toggle unit 13 through the crossbar 11.

The transmission toggle unit 13 receives packets transmitted from the transmitting core 10 at a high throughput and outputs them to the transmitting port 12 at a low throughput based on the throughput of the link 20. If detecting an end of a packet, the transmission toggle unit 13 changes the transmission port 12. The port 12 of the transmitting chip 2 may be called a transmitting port 12, and the port 12 of the receiving chip 2 may be called a receiving port 12.

The transmission toggle unit 13 distributes the packets input from the transmitting core 10 alternately between the Port #0 and the Port #1 in order from the preset starting port 12 (Port #0 in the example illustrated in FIG. 2). In other words, for example, the transmission toggle unit 13 changes the transmitting port 12 to be used for packet transmission for each packet by starting from the preset starting port 12.

In the example illustrated in FIG. 2, the packets P1 and P3 are distributed to the Port #0, and the packets P2 and P4 are distributed to the Port #1 (see Reference S2).

Next, the data (packets) are transmitted over the links 20. The link 20 to which the Port #0 is connected may be called Link #0, and the link 20 to which the Port #1 is connected may be called Link #1.

In the example illustrated in FIG. 2, the packets P1 and P3 are transmitted over Link #0, and the packets P2 and P4 are transmitted over Link #1.

The links 20 have a lower throughput than that within the CPUs (chips 2), and data are transmitted in a longer period of time than the time taken for data transfer within the bus in the chips 2 having a higher throughput (see Reference S3).

Within the links 20, the order of reception of packets at the receiving ports 12 may be different from the order of transmission of the packets due to the lengths of the packets, for example.

In the example illustrated in FIG. 2, the packet P4 transferred over Link #1 overtakes the packet P3 transferred over Link #0 and reaches the receiving port 12 first. In other words, for example, packet overtaking occurs between the different links 20.

The packets P1, P2, P3 and P4 reach the receiving ports 12 (Ports #0 and #1) that are terminations of the Links #0 and #1 in order of P1, P2, P4 and P3. This order of reaching is different from the order of transmission of the packets at the transmitting core 10.

Next, the reception toggle unit 14 receives the data from the receiving ports 12. The reception toggle unit 14 receives data by the toggling method that switches between Port #0 and Port #1 at each of breaks in a packet sequence (the end of each packet), and the packets received by the two ports 12 are taken out by serializing them. In this case, the reception toggle unit 14 receives the packets by alternately switching between the receiving port #0 and #1 in the same order as the switching between the transmitting ports #0 and #1 for distributing the packets to two Links #0 and #1 by the transmission toggle unit 13 (see Reference S4).

Thus, the reception toggle unit 14 receives the packets from the two receiving ports #0 and #1 in the same order as the order of transmission of the packets transmitted from the transmitting core 10. In other words, for example, the reception toggle unit 14 receives the packets P1, P2, P3, and P4 in the order. Even in a case where packet overtaking occurs between the two links 20, the reception toggle unit 14 may receive packets from the two receiving ports #0 and #1 in the same order as the order of transmission of the packets transmitted from the transmitting core 10.

The reception toggle unit 14 receives the data at the throughput of the links 20 and transmits the data to the receiving core 10 in accordance with the throughput of the CPU. The receiving core 10 may receive and process the packets in the same order as the order of transmission of the packets transmitted by the transmitting core 10.

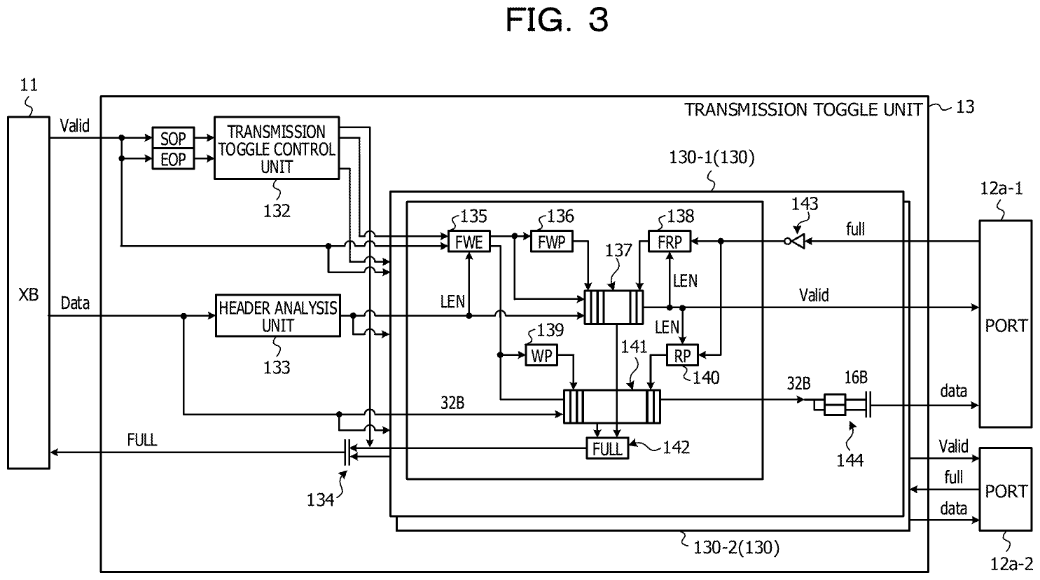

FIG. 3 is a diagram illustrating a configuration of the transmission toggle unit 13 of the communication control system 1 as an example of the embodiment. FIG. 3 illustrates a configuration of the transmission toggle unit 13 included in the chip 2a.

The transmission toggle unit 13 includes, as illustrated in FIG. 3, a transmission toggle control unit 132, a header analysis unit 133, a selector 134 and a plurality of (two in the example illustrated in FIG. 3) transmission buffer units 130-1 and 130-2.

The transmission buffer unit 130-1 is provided for the transmission port 12a-1, and the transmission buffer unit 130-2 is provided for the transmission port 12a-2.

The transmission buffer unit 130-1 and the transmission buffer unit 130-2 have the same configuration. For convenience, FIG. 3 illustrates the configuration of the transmission buffer unit 130-1, and the illustration of the configuration of the transmission buffer unit 130-2 is omitted.

As the references indicating the transmission buffer units, the references “130-1” and “130-2” are used for specifying corresponding ones of the plurality of transmission buffer units, but the reference “130” is used for indicating an arbitrary one of the plurality of transmission buffer units.

The transmission buffer units 130 are correspondingly provided for the plurality of (two in the example illustrated in FIG. 3) transmission ports 12.

Each of the transmission buffer units 130 includes an FWE 135, a FWP 136, a header FIFO buffer 137, an FRP 138, a WP 139, an RP 140, a payload buffer 141, a buffer-full notification unit 142, an inverter 143 and a speed adjustment unit 144.

WE stands for write enable. FIFO stands for first in, first out. WP stands for write pointer. RP stands for read pointer. FWP stands for FIFO write pointer. FRP stands for FIFO read pointer.

A set of two signals Valid and Data is input from the crossbar 11 to the transmission toggle unit 13.

Valid is a 2-bit signal, for example, and takes “01” indicating “Start Of Packet (SOP)”, “10” indicating “transferring” and “11” indicating “End Of Packet (EOP)”.

Valid is input to the transmission toggle control unit 132 and the transmission buffer unit 130. Data is input to the header analysis unit 133, the transmission buffer unit 130 and the payload buffer 141.

If Valid is “01”, the transmission toggle control unit 132 identifies a start of a packet (SOP). If Valid is “11”, the transmission toggle control unit 132 identifies an end of a packet (EOP).

The transmission toggle control unit 132 performs so-called toggle switching that alternately changes the transmission buffer unit 130 (transmission port 12) to which Data is to be written every time EOP is detected. Hereinafter, the transmission buffer unit 130 to which Data is to be written may be called a writing target transmission buffer unit 130.

The transmission toggle control unit 132 interprets Valid and performs toggle switching on the port 12 (buffer unit 130) to be connected.

Hereinafter, the transmission buffer unit 130 selected to be used for packet transmission by the transmission toggle control unit 132 may be called a selected transmission buffer unit 130.

The transmission toggle control unit 132 asserts the FWE 135 corresponding to the switching target port 12, that is, the FWE 135 in the selected transmission buffer unit 130. Thus, the data are written to the payload buffer 141 and the header FIFO buffer 137 provided in the selected transmission buffer unit 130. The selected transmission buffer unit 130 may also be called a writing target transmission buffer unit 130.

The FWP 136 is a pointer that manages a write position (WP) in the header FIFO buffer 137, and the FWP 136 is incremented by 1 if the FWE 135 is asserted. The FWE 135 is asserted if an SOP is detected.

The FRP 138 is a pointer that manages a read position (RP) in the header FIFO buffer 137, and increments the RP if the signal responded from the transmission port 12 is not full. After the RP is incremented once, the incrementation is inhibited until the transmission of the packet is completed. The completion of the transmission of a packet may be determined based on the value of LEN (LENGTH) indicating the packet length. A read-out operation from the header FIFO buffer 137 is performed if the connected transmission port 12 is vacant (is not full).

Data is data that are generated in the core 10 and are transmitted to the receiving chip 2 (chip 2b in this example) and includes header information and a payload. The header information is stored in the header FIFO buffer 137, and the payload is stored in the payload buffer 141.

The header analysis unit 133 extracts LEN based on the header information of Data. LEN extracted by the header analysis unit 133 is stored in the header FIFO buffer 137 as information (header information) on a packet.

The header FIFO buffer 137 holds header information of packets in FIFO. The header FIFO buffer 137 includes a storage area having 32 entries. The header FIFO buffer 137 consumes one entry for one packet to hold header information of the packet.

The header FIFO buffer 137 inputs Valid to the transmission port 12 in a state that full is not notified by the transmission port 12, for example.

The value of LEN read out from the header FIFO buffer 137 based on the pointer value indicated by the FRP 138 is used for reading out data from the payload buffer 141.

The transmission toggle control unit 132 has a function to use the same port 12 first for data transmission as the port 12 to be used by the reception toggle unit 14 in the receiving chip 2, which will be described below.

The WP 139 is a pointer that manages a write position (WP) in the payload buffer 141 and is incremented if the FWE 135 is asserted. The FWE 135 is asserted until one whole packet is received.

The RP 140 is a pointer that manages a read position (RP) in the payload buffer 141 and is incremented by an amount equivalent to the packet length (LEN) if the signal responded from the transmission port 12 is not full.

The payload buffer 141 stores a payload of Data. The payload buffer 141 consumes one entry for each 32-B data. For example, the payload buffer 141 has a size of 4 KB (32 B×128).

The payload buffer 141 inputs a payload of Data to the transmission port 12 in a state that full is not notified by the transmission port 12, for example.

When the header FIFO buffer 137 and the payload buffer 141 almost have a full state, the header FIFO buffer 137 and the payload buffer 141 assert full (full notification) and notify it to the crossbar 11 through the buffer-full notification unit 142 so that data transmission from the crossbar 11 is inhibited. The full notification from the buffer-full notification unit 142 is input to the selector 134.

The selector 134 selects the buffer unit 130 whose buffer-full (full) state is to be notified to the crossbar 11. The selector 134 notifies the crossbar 11 of the full state of the port 12 to be arbitrated in the crossbar 11.

The selector 134 toggles the port 12 after an arbitration for the previous packet is completed in the crossbar 11. The completion of the arbitration for the previous packet may be determined based on SOP. An SOP detection notification from the transmission toggle control unit 132 is input to the selector 134. The selector 134 changes (toggles) the port 12 exhibiting full to the crossbar 11 based on the SOP.

The inverter 143 inverts the full notification from the transmission port 12 and inputs the result to the FRP 138 and the RP 140.

The speed adjustment unit 144 decelerates the output (32 B) from the payload buffer 141 in accordance with the data transfer width (16 B) of the transmission port 12.

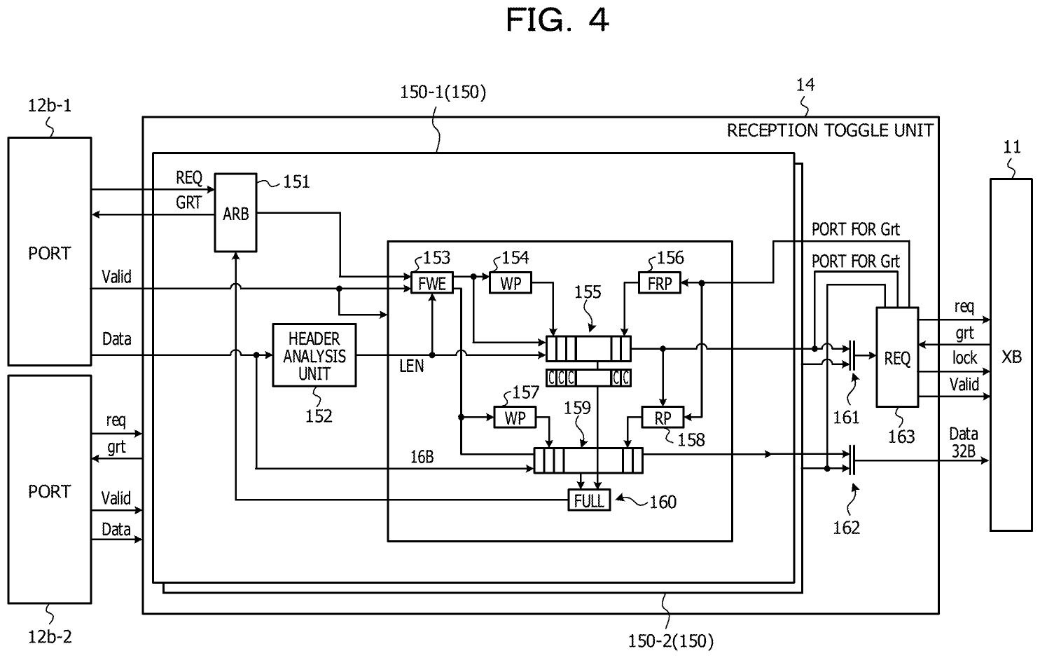

FIG. 4 is a diagram illustrating a configuration of the reception toggle unit 14 in the communication control system 1 as an example of the embodiment. FIG. 4 illustrates a configuration of the transmission toggle unit 13 included in the chip 2b.

The reception toggle unit 14 includes, as illustrated in FIG. 4, a reception toggle control unit (req) 163, a header analysis unit 133, selectors 161 and 162 and a plurality of (two in the example illustrated in FIG. 4) reception buffer units 150-1 and 150-2.

The reception buffer unit 150-1 is provided for the reception port 12b-1, and the transmission buffer unit 150-2 is provided for the transmission port 12b-2.

The reception unit 150-1 and the reception buffer unit 150-2 have the same configuration. For convenience, FIG. 4 illustrates the configuration of the reception buffer unit 150-1, and the illustration of the configuration of the reception buffer unit 150-2 is omitted.

As the references indicating the reception buffer units, the references “150-1” and “150-2” are used for specifying corresponding ones of the plurality of reception buffer units, but the reference “150” is used for indicating an arbitrary one of the plurality of reception buffer units.

The reception buffer units 150 are correspondingly provided for the plurality of (two in the example illustrated in FIG. 4) reception ports 12.

Each of the reception buffer units 150 includes an arbitration unit (arb) 151, a header analysis unit 152, an FWE 153, a FWP 154, a WP 157, a header FIFO buffer 155, an FRP 156, an RP 158, a payload buffer 159, and a buffer-full notification unit 160.

The reception port 12 (12b-1) inputs signals Valid, Data, and req to the corresponding reception buffer unit 150.

The reception port 12 (12b-1) transmits req to the reception toggle unit 14. If the buffers (header FIFO buffer 155 and the payload buffer 159) within the reception toggle unit 14 is vacant, the arbitration unit 151 returns grt to the reception port 12. The arbitration unit 151 further asserts the FWE 153. Thus, the data are written to (received by) the payload buffer 159 and the header FIFO buffer 155 provided in the reception buffer unit 150.

The reception port 12 having obtained grt transmits Valid and Data to the reception toggle unit 14. The reception buffer unit 150 interprets Valid and writes Data to the buffers (the header FIFO buffer 155 and the payload buffer 159) if the Data is valid data.

In the reception toggle unit 14, the buffers include the header FIFO buffer 155 and the payload buffer 159, like the transmission toggle unit 13.

The FWP 154 is a pointer that manages a write position (WP) in the header FIFO buffer 155, and the FWP 154 is incremented by 1 if the FWE 153 is asserted. The FWP 154 is incremented for each packet.

The FRP 156 is a pointer that manages a read position (RP) in the header FIFO buffer 155 and is incremented if the FRP 156 receives grt from a reception toggle control unit 163, which will be described below.

The header FIFO buffer 155 increments for each packet (for each one packet).

The header FIFO buffer 155 holds header information of packets in FIFO. The packet information includes a packet length (LEN). The header FIFO buffer 155 includes a storage area having 32 entries. The header FIFO buffer 155 consumes one entry for one packet to hold header information of the packet.

The value of LEN read out from the header FIFO buffer 155 based on the pointer value indicated by the FRP 156 is used for reading out data from the payload buffer 159.

The WP 157 is a pointer that manages a write position (WP) in the payload buffer 159 and is incremented if the FWE 153 is asserted. The FWE 153 is asserted until one whole packet is received.

The RP 158 is a pointer that manages a read position (RP) in the payload buffer 159 and is started to increment when the RP 158 receives grt from the reception toggle control unit 163.

The payload buffer 159 stores a payload of Data. The payload buffer 159 consumes one entry for each 32-B data. For example, the payload buffer 159 has a size of 4 KB (32 B×128).

The WP 157 is incremented for each reception of 32-B data. Because the input is 16-B, the WP 157 is incremented every two receptions. The RP 158 is kept being incremented from a time when req is received from the reception toggle control unit 163 to a time when one packet is read out.

According to a method that recognizes the end of a packet based on Valid like the manner in the transmission toggle unit 13, data may not be transmitted to the downstream side (such as the crossbar 11) until whole data are received. The reception toggle unit 14 reads out the size of a packet from the header included in the beginning of the packet and determines whether the half or more of the packet has been received. After the half or more of the packet is received, the reception buffer unit 150 starts the data transmission processing. This is because the destination has a bus having the double width of that of the link 20, and there is no data to be transmitted unless the transmission is started after the half or more of data of the packet is received, resulting in missing of data in the packet.

When the header FIFO buffer 155 and the payload buffer 159 almost have a full state, the header FIFO buffer 155 and the payload buffer 159 assert a full signal (full notification) and notify it to the arbitration unit 151 through the buffer-full notification unit 160 so that data transmission from the reception port 12 is inhibited. Therefore, the full notification from the buffer-full notification unit 160 is input to the arbitration unit 151.

The header information (such as LEN) read out from the header FIFO buffer 155 is input to the reception toggle control unit 163 through the selector 161.

The data read out from the payload buffer 159 are input to the crossbar 11 through the selector 162.

The selector 161 selectively switches between the header information (LEN) output from the reception buffer unit 150-1 and the header information output from the reception buffer unit 150-2 to input them to the reception toggle control unit 163. The switching by the selector 161 is performed under control of the reception toggle control unit 163.

The selector 162 selectively switches between the data output from the reception buffer unit 150-1 and the data output from the reception buffer unit 150-2 to input them to the crossbar 11. The switching by the selector 161 is performed under control of the reception toggle control unit 163.

The reception toggle control unit 163 performs a control for toggling the reception port 12 to participate in an arbitration for transmission to the crossbar 11. The reception toggle control unit 163 performs toggle switching between the reception buffer unit 150-1 (reception port 12b-1) and the reception buffer unit 150-2 (reception port 12b-2) at a break in a packet sequence (the end of a packet).

The toggle switching is performed by inputting a switching control signal to the selectors 161 and 162, for example.

The reception toggle control unit 163 transmits req (notification of participation to the arbiter) to the crossbar 11. When grt is responded from the crossbar 11, the reception toggle control unit 163 transmits lock to the crossbar 11 to acquire exclusion. Then, the reception toggle control unit 163 transmits Valid to the crossbar 11.

The reception toggle control unit 163 grasps a break in a packet sequence (an end of a packet) based on a packet length (LEN) obtained from the header FIFO buffer 155 in the reception buffer unit 150 through the selector 161, for example. The determination of a break in a packet sequence is not limited thereto but may be executed properly in a different manner. For example, the reception toggle control unit 163 may detect a rising edge of Data received by the reception port 12 to recognize a break in the packet sequence (or an end of the packet).

The reception toggle control unit 163 uses the same (matching) port (starting port) 12 for the first data communication as that used by the transmission toggle control unit 132 in the transmitting chip 2.

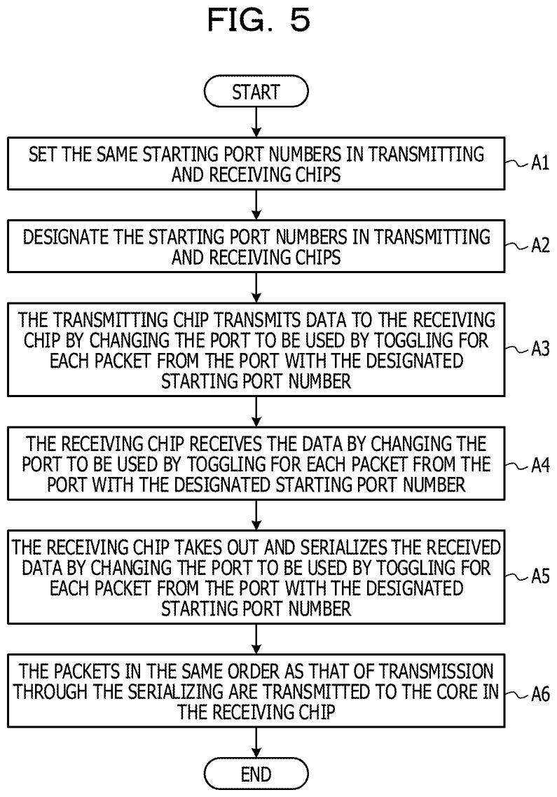

Processing relating to data communication in the communication control system 1 as an example of the embodiment configured as described above will be described with reference to a flowchart (including steps A1 to A6) illustrated in FIG. 5.

In step A1, the transmitting chip 2 and the receiving chip 2 set the same starting port number. In other words, for example, as starting ports 12, the transmission toggle control unit 132 in the transmission toggle unit 13 and the reception toggle control unit 163 in the reception toggle unit 14 set the ports 12 having the same port number.

In step A2, the transmitting chip 2 and the receiving chip 2 designate the same starting port number.

In step A3, the transmission toggle unit 13 in the transmitting chip 2 starts data communication by using the starting port 12 having the designated same port number. In other words, for example, the transmission toggle unit 13 starts data reception from the core 10 and transmission of the received data by using the set starting port 12 (such as Port #0). The reception toggle unit 14 starts the data reception by using the set starting port 12 (such as Port #0).

The transmission toggle unit 13 alternately changes the port 12 for each packet by toggling to transmit data to the destination chip 2.

In step A4, the reception toggle control unit 163 in the receiving chip 2 starts packet reception by using the designated starting port number first and performs packet reception by alternately changing the port 12 to be used for each packet by toggling.

In step A5, the reception toggle control unit 163 in the receiving chip 2 starts packet reception from the reception port 12 having the designated starting port number and takes out and sequentially aligns (serializing) received data from the ports 12 used for packets onto a buffer, for example.

In step A6, the reception buffer unit 150 in the receiving chip 2 transmits the serialized packets in the same order as the order of transmission of the packets in the transmitting chip 2 to the core 10 in the receiving chip 2 and ends the processing.

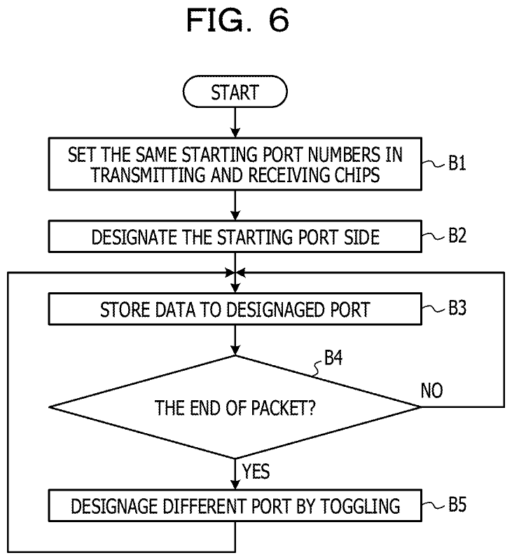

Next, processing by the transmission toggle unit 13 in the communication control system 1 as an example of the embodiment will be described with reference to a flowchart (including steps B1 to B5) illustrated in FIG. 6.

In step B1, the transmission toggle unit 13 sets the same starting port number as that of the receiving chip 2. In step B2, the transmission toggle unit 13 designates the starting port number.

In step B3, the transmission toggle unit 13 stores data to the designated port 12.

In step B4, the transmission toggle unit 13 checks whether the data that are currently being transmitted corresponds to an end of the packet. If the data do not correspond to an end of the packet as a result of the check (see NO route in step B4), the processing returns to step B3.

On the other hand, if the data correspond to an end of the packet (see YES route in step B4), the transmission toggle control unit 132 in the transmission toggle unit 13 in step B5 designates a different port 12 by toggling. Then, the processing returns to step B3.

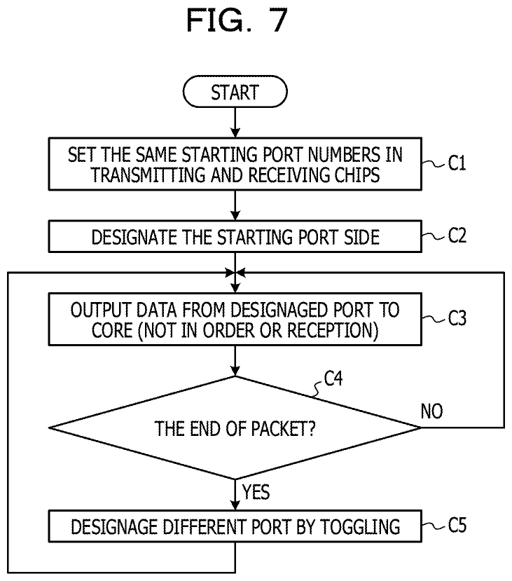

Next, processing by the reception toggle unit 14 in the communication control system 1 as an example of the embodiment will be described with reference to a flowchart (including steps C1 to C5) illustrated in FIG. 7.

In step C1, the reception toggle unit 14 sets the same starting port number as that of the transmitting chip 2. In step C2, the reception toggle unit 14 designates the starting port number.

In step C3, the reception toggle unit 14 stores data from the designated port 12 to the core 10.

In step C4, the reception toggle unit 14 checks whether the data that are currently being received corresponds to an end of the packet. If the data do not correspond to an end of the packet as a result of the check (see NO route in step C4), the processing returns to step C3.

On the other hand, if the data correspond to an end of the packet (see YES route in step C4), the reception toggle control unit 163 in the reception toggle unit 14 in step C5 designates a different port 12 by toggling. Then, the processing returns to step C3.

In the communication control system 1 as an example of the embodiment, a plurality of packets may be transmitted in parallel from the transmitting chip 2 to the receiving chip 2 through the plurality of links 20, which may improve the throughput of the communication.

After the transmission toggle unit 13 in the transmitting chip 2 and the reception toggle unit 14 in the receiving chip 2 designate the same starting port 12, the transmission toggle unit 13 alternately changes the port 12 for each packet by toggling to transmit data to the receiving chip 2 through the plurality of links 20.

In the receiving chip 2, the reception toggle unit 14 alternately changes the reception port 12 for each packet by toggling through the plurality of links 20.

Thus, even when packet overtaking occurs between the plurality of links 20, the receiving chip 2 may receive the packets in the same order as the order of transmission from the transmitting chip 2.

In other words, the receiving chip 2 may obtain data (packet group) in the order of submission of the data in the transmitting chip 2. Thus, without any large changes, the transmitting chip 2 may highly conveniently use the plurality of ports 12 by regarding them as one port 12.

Also, without changing the data structure of packets in an existing communication control system, the communication control system 1 may be introduced at lower introduction costs.

The disclosed technology is not limited to the aforementioned embodiment but may be implemented by making various changes thereto without departing from the spirit and scope of the embodiment. The configurations and processes of the embodiment may be chosen as required or may be combined properly.

For example, in the aforementioned embodiment, two links 20 are used to transmit data in parallel (by duplexing) from the transmitting chip 2 to the receiving chip 2 so that the throughput between the chips 2 may be improved. However, embodiments are not limited thereto. In other words, for example, two or more links 20 may be used to transmit data.

In a case where three or more links 20 are used as described above, three or more ports 12 are connected to the links 20 between the transmitting chip 2 and the receiving chip 2. The transmission toggle control unit 132 may switch among those ports 12 (links 20) sequentially in predetermined order every time one packet is transmitted.

Thus, the throughput between the chips 2 may be improved, compared with a case where packets are distributed to two duplexed links 20 between the chips 2.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication control system comprising:
a first processor; and
a second processor coupled to the first processor via a plurality of communication lines and the second processor configured to
select, for each packet of a plurality of packets, a communication line from the plurality of communication lines in specific order, and
sequentially transmit each packet of the plurality of packets by using the selected communication line of the plurality of communication lines,
wherein the first processor is configured to sequentially receive each packet of the plurality of packets by selecting a communication line from the plurality of communication lines in the specific order.

2. The communication control system according to claim 1, wherein
the first processor and the second processor are configured to select a same communication line from the plurality of communication lines to start communication between the first processor and the second processor.

3. The communication control system according to claim 1, wherein
each of the first processor and the second processor is a chip.

4. The communication control system according to claim 1, wherein
the plurality of communication lines is two communication lines, and
the specific order is alternate.

5. The communication control system according to claim 1, wherein
a size of each packet of the plurality of packets is a variable length.

6. A communication control method comprising:
selecting, by a first processor coupled to a second processor via a plurality of communication lines, a communication line from the plurality of communication lines in specific order for each packet of a plurality of packets; and
sequentially transmitting, by the first processor, each packet of the plurality of packets by using the selected communication line of the plurality of communication lines; and
sequentially receiving, by the second processor, each packet of the plurality of packets by selecting a communication line from the plurality of communication lines in the specific order.

7. The communication control method according to claim 6, wherein
the first processor and the second processor are configured to select a same communication line from the plurality of communication lines to start communication between the first processor and the second processor.

8. The communication control method according to claim 6, wherein
each of the first processor and the second processor is a chip.

9. The communication control method according to claim 6, wherein
the plurality of communication lines is two communication lines, and
the specific order is alternate.

10. The communication control method according to claim 6, wherein
a size of each packet of the plurality of packets is a variable length.

11. A non-transitory computer-readable medium storing instructions comprising:
one or more instructions for selecting, by a first processor coupled to a second processor via a plurality of communication lines, a communication line from the plurality of communication lines in specific order for each packet of a plurality of packets; and
one or more instructions for sequentially transmitting, by the first processor, each packet of the plurality of packets by using the selected communication line of the plurality of communication lines; and
one or more instructions for sequentially receiving, by the second processor, each packet of the plurality of packets by selecting a communication line from the plurality of communication lines in the specific order.
